(19) United States
(12) Patent Application Publication
(10) Pub. No.: US 2004/0153434 A1
(43) Pub. Date: Aug. 5, 2004

(54) Method and apparatus for documenting use of a trademark or service mark

(76) Inventors: Jeffrey Morris Cogen, Flemington, NJ (US); Thomas J. Colson, Clarence, NY (US)

Correspondence Address: SIMPSON & SIMPSON, PLLC, 5555 MAIN STREET, WILLIAMSVILLE, NY, 14221-5406, US

(21) Appl. No.: 10/477,084

(22) PCT Filed: May 8, 2001
(86) PCT No.: PCT/US01/14720

(51) Int. Cl. G06F 7/00

(52) U.S. Cl. 707/1

(57) ABSTRACT

The present invention comprises a method of documenting first use of a trademark including the steps of posting the trademark in a virtual storefront file accessible over a global information network, retrieving the storefront file, rendering the retrieved storefront file into a storable file format, storing the rendered retrieved storefront file in a memory, and notarizing the rendered retrieved storefront file to document a date and time of first use of the trademark. The invention also includes an apparatus to implement the method. The invention includes the steps of digitally notarizing a web page, web site, or portion of a web site in order to provide proof that the content was present at the web site on a particular date. In particular, an Internet-based advertisement for goods and services which uses a trademark or service mark, or an Internet-based “virtual storefront” which uses a trademark of service mark, is digitally notarized to provide proof that the trademark or service mark was in use at a given time and in a specific manner.

### TECHNICAL FIELD

The present invention relates to the field of trademarks and service marks; more specifically, it relates to a method and apparatus for establishing legal rights to a trademark or service mark via a global information network.

### BACKGROUND ART

A trademark is a word, phrase, sound, color, symbol, design, or other indicator of source, or a combination thereof, which identifies and distinguishes the source of the goods of one party from those of others. A service mark is a word, phrase, symbol, sound, color, design, or other indicator of source, or a combination thereof, which identifies and distinguishes the source of the services of one party from those of others. Together, trademarks and service marks are called marks. Marks can have extremely high economic value, and are an important aspect of brand recognition. Well known examples include the classic Campbell soup red and white label, the Hershey Kiss design, the Morton Umbrella Girl, and the McDonald's Golden Arches.

In 1998, there were 1,697,620 new applications for service mark and trademark registrations worldwide, according to the World Intellectual Property Organization statistics. That number is expected to approach 3,000,000 for the year 2000. The 1998 and estimated 2000 numbers for the United States are about 250,000 and 450,000, respectively. The above statistics are only for registrations at the national level. In addition, registration systems exist at the sub-national level. For example, in the United States, registration is possible at the state level, independent of any national registrations.

Each country and each state have their own rules regarding trademark registration. However, the United States system is not atypical, and will be discussed in detail to illustrate several key concepts.

In the United States, federal registration is not required to establish rights in a mark, nor is it required to begin use of a mark. However, federal registration can secure benefits beyond the rights acquired by merely using a mark. For example, the owner of a federal registration is presumed to be the owner of the mark for the goods and services specified in the registration, and to be entitled to use the mark nationwide.

There are two related but distinct types of rights in a mark: the right to register and the right to use. Generally, the first party who either uses a mark in commerce or files an “Intent to Use” application in the United States Patent and Trademark Office (USPTO) has the ultimate right to register that mark (assuming there are no other marks previously registered such that registration of the new mark would be likely to cause confusion or to deceive the public). The USPTO's authority is limited to determining the right to register. The right to use a mark can be more complicated to determine. This is particularly true when two parties have begun use of the same or similar marks without knowledge of one another and neither has a federal registration. Only a court can render a decision about the right to use, such as issuing an injunction or awarding damages for infringement. It should be noted that a federal registration could provide significant advantages to a party involved in a court proceeding.

An application for federal registration of a mark in the United States ultimately requires the applicant to specify: 1) First use of the mark anywhere, and 2) First use of the mark in commerce that is regulated by the U.S. Congress (use in “commerce” under Article III of the U.S. Constitution, e.g., interstate commerce, commerce with an Indian reservation, commerce with a foreign nation, etc.).

Conventionally, “first use anywhere” for a trademark means that the product bearing the mark has been shipped. It doesn't require an actual sale. As stated by P. Gima and S. Elias in The Trademark Registration Kit: Register Your Trademark Without a Lawyer (Nolo, 1999, page 2/3): “For products, your mark is in use if the mark appears on the goods or on labels or tags attached to them, and the goods have either been shipped to a store for sale or use as a sample, or are available for sale by mail or over the Internet.” “For services, your mark is in use if the services are actually being marketed under the mark and you can legitimately deliver them to end users.” The marketing of services over a global information network probably qualifies for first use anywhere.

Commerce that is regulated by the U.S. congress includes shipping goods interstate, shipping goods out of the country, or using the mark to advertise services outside of a state or advertise services that cater to interstate or international travelers.

Importantly, the date of first use anywhere is what establishes the beginning of one's legal right to a mark. Under the common law, trademark rights arise from use. He or she who is first to use a mark in commerce in a particular territory enjoys superior rights to those who use a confusingly similar mark in that territory thereafter. Therefore, it is important to document the first use of a mark. This is important not only for the registration process but also in case one becomes involved in a trademark dispute.

In practice, many companies postpone trademark and service mark registration for long periods of time even as they continue to use the marks on their goods or services and continue to invest in building brand recognition around those unregistered marks. As time goes by, it becomes more and more difficult to prove a specific date of first use of the mark, and companies must often rely on approximate dates.

Failure to document dates of first use and use in commerce is so problematic that the USPTO Trademark Manual of Examining Procedure contains a section (Chapter 900 section 904.07) addressing the issue of indefinite dates of use in trademark applications. The section, entitled “Indefinite Dates of Use,” includes the following statement: “When a month and year are given without a specified day, the date presumed is the last day of the month. When only a year is given, the date presumed is the last day of the year.” It is further stated: “This presumption may be applicable to a determination of the applicant's rights . . . .”

As a prerequisite to registration of a mark, an applicant must submit a specimen of the mark as it is used in commerce. For goods (trademarks), acceptable specimens include labels, tags, or containers showing the mark, or a photograph of a product bearing the mark. Requirements of a specimen are outlined in the above-mentioned USPTO trademark manual of examination procedure, and in 37 CFR §§2.56, 2.59. Also acceptable is any catalog or similar specimen as a display associated with the goods, provided that (1) it includes a picture of the relevant goods, (2) it includes the mark sufficiently near the picture of the goods to associate the mark with the goods, and (3) it includes information necessary to order the goods. Any form of advertising that satisfies these criteria is considered a display associated with the goods. For services (service marks), acceptable specimens include a variety of advertising and marketing materials such as newspaper and magazine ads, brochures, billboards, direct mail pieces and restaurant menus.

### Legal Analysis

Title 15, Section 1127 provides the legal definition of “use in commerce”, a prerequisite for federal registration. Prior to Nov. 16, 1989, use of the mark in commerce was required even to apply for federal registration. Now, the applicant need only have a bona fide intention to use the mark in commerce, although use in commerce is still required for registration. Interestingly, “use in commerce” is defined differently for trademarks and service marks, as explained herebelow:

### Use in Commerce Requirement for Trademarks

15 U.S.C. §1127 provides, in pertinent part:

“. . . a mark shall be deemed to be in use in commerce—

(1) on goods when—

(A) it is placed in any manner on the goods or their containers or the displays associated therewith or on the tags or labels affixed thereto, or if the nature of the goods makes such placement impracticable, then on documents associated with the goods or their sale, and

(B) the goods are sold or transported in commerce . . .”

### Use in Commerce Requirement for Service Marks

15 U.S.C. §1127 provides, in pertinent part:

“. . . a mark shall be deemed to be in use in commerce—

(2) on services when it is used or displayed in the sale or advertising of services and the services are rendered in commerce, or the services are rendered in more than one State or in the United States and a foreign country and the person rendering the services is engaged in commerce in connection with the services.”

Thus, it is seen that the “use in commerce” requirements are different for trademarks and service marks. For trademarks, the mark must be placed on the goods or their containers or displays associated therewith AND the goods must be sold or transported in commerce. Advertising does not usually satisfy the use requirement for trademarks. On the contrary, for service marks, advertising of services using the mark does suffice, so long as the services are also rendered in more than one State or in the United States and a foreign country.

The law is presently evolving as to the effect of posting a trademark or service mark on a web site vis-a-vis the “use in commerce” requirement. It is interesting to note that the Lanham Act includes only one definition for “use in commerce” (15 U.S.C. §1127 cited above) and that this definition arguably applies both in the case of one applying for federal registration of a mark, and to determine if an infringer uses an infringing mark “in commerce” for purposes of remedies provided by the Lanham Act. There has been some speculation that, despite the single definition in the Lanham Act, the USPTO applies a higher standard for registration than do the courts in infringement actions. Nevertheless, as of the time of filing of the application for this patent, no court has directly ruled on whether posting of a trademark or service mark on a web site would satisfy the “use in commerce” requirement of 15 U.S.C. §1127 as it applies to registration. Courts have, however, come close to addressing the issue in right to use proceedings.

In Intermatic v. Toeppen, 41 USPQ2d 1223 (N.D. Ill. 1996), an alleged cybersquatter raised as a defense that ownership and use of a domain name was not “use in commerce” under the Lanham Act, and that Section 43(c) of the Lanham Act didn't apply. In rebutting this argument, the Court stated, “Toeppen's use of the Internet satisfies the ‘in commerce’ requirement of Section 43(c). Toeppen also argues that he has not violated the Act because his use of the ‘intermatic.com’ domain name was not in commerce. This argument misses the mark. “Because Internet communications transmit instantaneously on a worldwide basis there is little question that the ‘in commerce’ requirement would be met in a typical Internet message, be it trademark infringement or false advertising.” (citing 1 Gilson, Trademark Protection and Practice, §5.11[2], p.5-234 (1996).) It is interesting that the Court didn't say that such Internet use would satisfy the “in commerce” requirement for federal registration, but, since there is only one definition of use in commerce in the Lanham Act, presumably such use would qualify as use in commerce for federal registration.

In Planned Parenthood Federation of America Inc. v. Bucci, 42 USPQ2d 1430 (S.D.N.Y. 1997), the defendant Bucci registered the domain name “plannedparenthood.com” and the plaintiff, Planned Parenthood Federation of America Inc. sued to enjoin the defendant from using the domain name. The court, citing the Intermatic v. Toeppen case, supra, acknowledged that courts sometimes apply a different “use in commerce” standard for infringement activity than the PTO uses under §1127 for purposes of qualifying for federal registration in the first instance, but nevertheless concluded that the defendant's use of the domain name qualified as “use in commerce” under §1127.

As use of the Internet proliferates, and as more and more goods and services are advertised and made available via the Internet, it is logical to assume that the USPTO and the courts will eventually recognize web site postings of trademarks and service marks as “use in commerce” under 15 U.S.C. §1127.

There has been a long felt need, then, for a method and apparatus to facilitate and unambiguously document the date of first use of a trademark or service mark. In addition, a system and method is needed for unambiguous documentation of date of first use in commerce of a trademark or service mark.

### DISCLOSURE OF INVENTION

Internet sites are widely used to advertise goods and services, as well as to serve as points of sale (“virtual storefronts”) for goods and services. At virtual storefront web sites, a customer can generally order or find out how to order goods or services. In addition, customers can often search for and conduct research into goods and services at a virtual storefront web site.

The present invention comprises a method of documenting first use of a trademark including the steps of posting the trademark in a virtual storefront file accessible over a global information network, retrieving the storefront file, rendering the retrieved storefront file into a storable file format, storing the rendered retrieved storefront file in a memory, and notarizing the rendered retrieved storefront file to document a date and time of first use of the trademark. The invention also includes an apparatus to implement the method. The invention includes the steps of digitally notarizing a web page, web site, or portion of a web site in order to provide proof that the content was present at the web site on a particular date. In particular, an Internet-based advertisement for goods and services which uses a trademark or service mark, or an Internet-based “virtual storefront” which uses a trademark of service mark, is digitally notarized to provide proof that the trademark or service mark was in use at a given time and in a specific manner.

More specifically, the present invention utilizes a documentation process to initiate notarization of a client's web pages that utilize marks in conjunction with advertisements or commercial offers. The documentation process comprises a mark database. Electronic records of the web page content and the notarization data are stored in a mark database, and can optionally be provided to the client.

Thus, one object of the invention is to provide a system and method to unambiguously prove that a mark was in use or in use in commerce, both of which are important events in establishing rights to a mark.

Another object of the invention is to provide a system and method for creating reliable specimens to be used in applications for registration of marks.

Other benefits and advantages of the present invention will become apparent upon a reading of the following detailed description in view of the drawings and appended claims.

### BRIEF DESCRIPTION OF DRAWINGS

FIG. 1 is a representative diagram of one embodiment of the system of the present invention for establishing legal rights to a trademark or service mark via a global information network;

FIG. 2 is a representative diagram of a second embodiment of the system of the present invention for establishing legal rights to a trademark or service mark via a global information network;

FIG. 3 is a representative diagram of a third embodiment of the system of the present invention for establishing legal rights to a trademark or service mark via a global information network; and,

FIG. 4 is a representative diagram of one embodiment of the method of the present invention for establishing legal rights to a trademark or service mark via a global information network.

### MODES FOR CARRYING OUT THE INVENTION

Glossary of Terms and Acronyms

The following terms and acronyms are used throughout the detailed description:

Mark. A trademark or service mark, or any similar indicator of source or origin of a good or service, respectively.

Global Information Network. Any computer network, and, in a preferred embodiment, the Internet.

Data file. A collection of bits and bytes that has a name, called the filename. Most information stored in a computer must be in a data file.

Email (Electronic mail). The transmission of messages over communications networks. The messages can be notes entered from the keyboard or electronic files stored on disk.

FTP. File Transfer Protocol, the protocol used on a global information network for sending files.

HTML. HyperText Markup Language, which defines the structure and layout of a Web document by using a variety of tags and attributes. Computer software codes for attaching presentation and linking attributes to informational content within documents. Documents sent to the Web browser contain HTML codes (referred to as “tags”) embedded within the informational content of the document. When the Web document (or HTML document) is subsequently received by a Web browser, the codes are interpreted by the browser and used to parse and display the document. Additionally HTML tags can be used to create links to other Web documents (commonly referred to as “hyperlinks”).

HTTP (HyperText Transfer Protocol). The standard World Wide Web protocol used for the exchange of information (such as HTML documents, and Web browser requests for such documents) between a browser and a Web server. HTTP includes a number of different types of messages which can be sent from the client to the server to request different types of server actions. For example, a “GET” message, which has the format GET, causes the server to return the document or file located at the specified URL. In the present invention, HTTPS (secure HTTP) may be used instead of HTTP if secure transmission is desired.

Hyperlink. A navigational link from one document to another that can be selected by clicking on it using a mouse, which causes the Web browser to display the linked document.

Internet. A collection of interconnected public and/or private networks that are linked together by a set of standard protocols such as TCP/IP and HTTP, to form a global, distributed network. The term “Internet” is also intended to encompass changes and additions to existing standard protocols that may be made in the future.

Notarization. The process of validating or attesting a legal document. Digital notarization is a process whereby the contents of a computer file, including a web page, can be digitally validated and attested.

Online form. A formatted document containing blank fields that users can fill in with data via a web browser over a global information network. The form appears on the user's display screen and the user fills it in by selecting options with a pointing device or typing in text from the computer keyboard. The data can then be sent directly to a forms processing application (program), which enters the information into a database or otherwise utilizes the information. Online forms are common on the World Wide Web because the HTML language has built-in codes for displaying form elements such as text fields and check boxes. Typically, a CGI program processes the data entered into a Web-based form.

Render. To produce a facsimile or reproduction of a displayed file by converting the browser or other screen display of the file to a different file format. An example is creating a PDF file from a web page displayed on a browser, in which case the web page is rendered as a PDF file.

Server. A computer or device on a network that manages network resources. For example, web server is a computer that delivers (serves up) Web pages. Every Web server has an IP address and possibly a domain name. For example, if you enter the URL http://www.xyz.com/index.html in your browser, this sends a request to the server whose domain name is xyz.com. The server then fetches the page named index.html and sends it to your browser. Most computers can be turned into a Web server by installing server software and connecting the machine to a global information network.

Upload. To transmit data from a computer to a bulletin board service, mainframe, or network. For example, if you use a personal computer to log on to a network and you want to send files across the network, you must upload the files from your PC to the network.

URL (Uniform Resource Locator). A unique address which fully specifies the location of a file or other resource on a global information network. The general format of a URL is protocol://machine address:port/path/filename. The port specification is optional.

Web browser. A program which sends requests to another program in a distributed system in which a program at one site sends a request to a program at another site and waits for a response. Typically the Web browser receives Web pages or files from a server. The two most popular browsers are Netscape Navigator and Microsoft Internet Explorer. Both of these are graphical browsers, which means that they can display graphics as well as text

Web page. A document on the World Wide Web. Every Web page is identified by a unique URL (Uniform Resource Locator).

Web site. A computer system for serving informational content over a network using the standard protocols of the World Wide Web. Typically, a Web site corresponds to a particular Internet domain name, such as “IP.COM,” and includes the content associated with a particular organization. As used herein, the term is generally intended to encompass both the hardware/software server components that serve the informational content over the network, and additional hardware/software components, including any non-standard or specialized components, that interact with the server components to perform services for Web site users.

World Wide Web (“Web”). A distributed collection of interlinked, user-viewable hypertext documents, commonly referred to as Web documents or Web pages, that are accessible via a global information network. Currently, the primary standard protocol for allowing applications to locate and acquire Web documents is HTTP, and the Web pages are encoded using HTML. The term “Web” is also intended to encompass changes and additions to existing standard protocols that may be made in the future.

Apparatus and Method

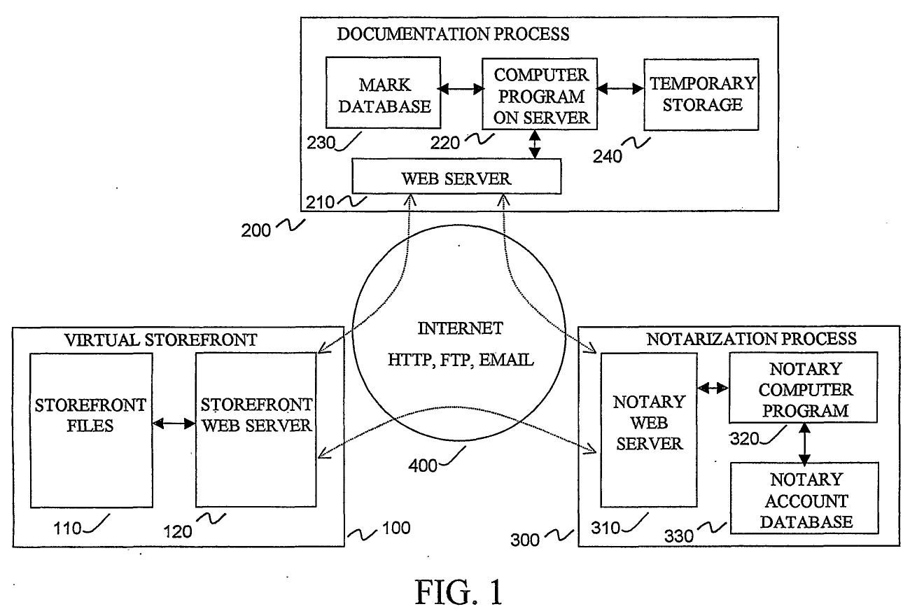

FIG. 1 illustrates one embodiment of the apparatus of the present invention. The apparatus of the invention broadly comprises virtual storefront 100, operatively arranged to permit a client to use a mark in one or more storefront files 110. The storefront files are either web pages, emails, or data files containing information pertaining to goods or services for sale (referred to hereinafter as goods and services information). For example, the goods and services information can include descriptions of goods or services, prices, specifications, pictures or other graphics files, or any other information useful to include in advertisements, catalogues, commercials, or sales brochures. In addition, the goods and services information in at least one storefront file 110 would include a mark.

Referring again to FIG. 1, a documentation process 200 is implemented by web server 210. Web server 210 is operatively arranged to run computer program 220 on web server 210, and mark database 230 is accessible by computer program 220. Computer program 220, via web server 210, is operatively arranged to retrieve storefront files 110 from the virtual storefront 100, via storefront web server 120. Computer program 220 is arranged to render storefront files 110 to a file format that can be conveniently stored in mark database 230. (As examples of rendering, computer program 220 can convert a storefront file 110 to PDF, MHT, HTML, JPG, TIF, GIF, or other file format that enables the content relayed in original storefront file 110 to be more conveniently notarized or stored in temporary storage 240 or in mark database 230.) The rendered file is then stored in temporary storage 240 or in mark database 230. Computer program 220 is also operatively arranged to initiate notarization via web server 210.

Notarization process 300 is described in U.S. patent application Ser. No. 09/625,185, filed Jul. 21, 2000, incorporated herein by reference; in corresponding Continuation-in-Part U.S. patent application Ser. No. 09/655,951, filed Sep. 6, 2000, incorporated herein by reference; in corresponding Continuation-in-Part U.S. patent application Ser. No. 09/705,975, filed Nov. 3, 2000, incorporated herein by reference.

After notarization, a notary file is returned to documentation process 200 via notary web server 310. The notary file is stored in mark database 230 along with the rendering of storefront files 110, creating a database record that can be used to document use of a mark.

It should be noted that in the embodiment shown in FIG. 1, virtual storefront 100 and documentation process 200 reside at distinctly separate physical locations and are connected via global information network 400. In the preferred embodiment shown in FIG. 1, the global information network is the Internet.

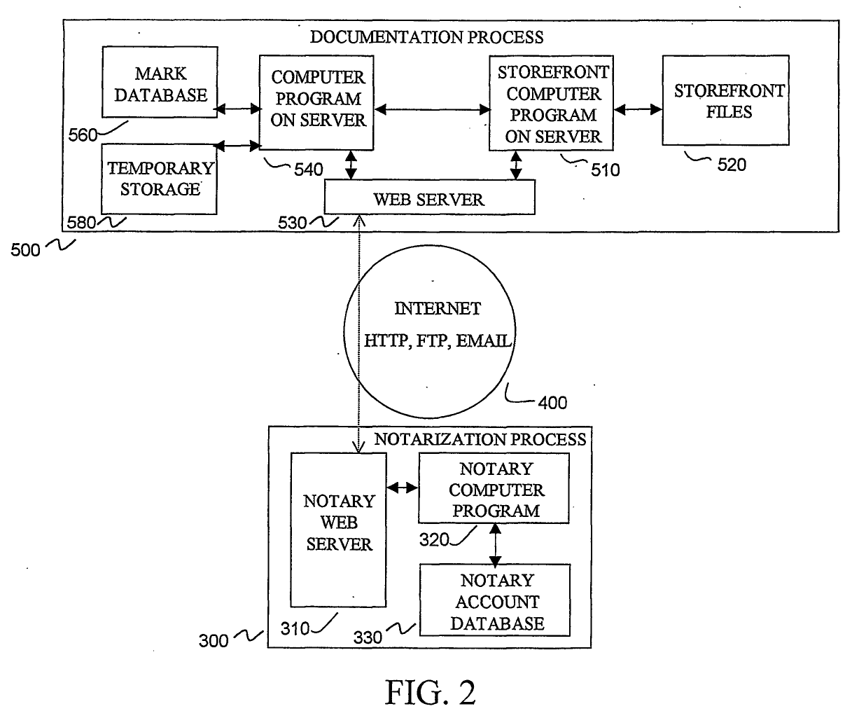

FIG. 2 illustrates a second embodiment of the system, wherein storefront computer program 510 is operatively arranged to implement documentation process 500. In the embodiment of FIG. 2, a client uses a mark in one or more storefront files 520 within documentation process 500. Storefront files 520 are either web pages, emails, or data files containing information pertaining to goods or services for sale (goods and services information). For example, the goods and services information can include descriptions of goods or services, prices, specifications, pictures or other graphics files, or any other information useful to include in advertisements, catalogues, commercials, or sales brochures. In addition, the goods and services information in at least one of storefront files 520 would include a mark.

Referring again to FIG. 2, documentation process 500 is implemented by computer program 540, running on web server 530, and mark database 560 which is accessible by computer program 540. Computer program 540 is operatively arranged to interact with storefront computer program 510 to retrieve storefront files 520. Computer program 540 is also arranged to render storefront files 520 to a file format that can be conveniently stored in mark database 560. (As examples of rendering, computer program 540 on web server 530 can convert storefront files 520 to PDF, MHT, HTML, JPG, TIF, GIF, or other file formats that enable the content relayed in the original storefront files 520 to be more conveniently notarized or stored.) The rendering is then stored in temporary storage 580 or in mark database 560 within documentation process 500, and computer program 540 then initiates notarization via web server 530. Notarization process 300 is the same as that described above in reference to FIG. 1.

After notarization, a notary file is returned to documentation process 500 via notary web server 310. The notary file is stored in mark database 560 along with the rendering of storefront files 520, creating a database record that can be used to document use of a mark.

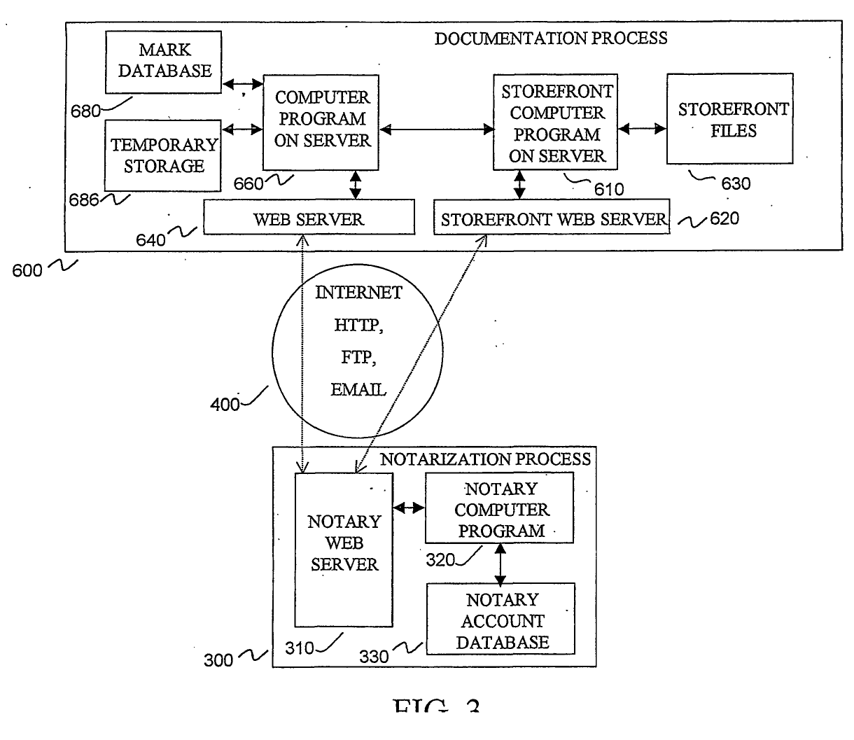

FIG. 3 illustrates a third embodiment of the system, wherein storefront computer program 610 implements documentation process 600 on storefront web server 620. In the embodiment of FIG. 3, a client uses a mark in one or more storefront files 630 within documentation process 600. The storefront files 630 are of the same type as those described in FIGS. 1 and 2. They are either web pages, emails, or data files containing information pertaining to goods or services for sale (goods and services information). For example, the goods and services information can include descriptions of goods or services, prices, specifications, pictures, or any other information useful to include in advertisements, catalogues, commercials, or sales brochures. In addition, the goods and services information in at least one of the storefront files 630 would include a mark.

Referring again to FIG. 3, documentation process 600 in this embodiment is implemented by computer program 660 running on web server 640, and mark database 680, which is accessible by computer program 660. Computer program 660 is operatively arranged to interact with storefront computer program 610 to retrieve storefront files 630. In addition, storefront computer program 610 is linked to storefront web server 620, enabling computer program 660 to access storefront computer program 610 via web server 620 and storefront web server 640. This ensures and documents that storefront files 630 are actually accessible via a global information network 400. After retrieving storefront files 630 from storefront computer program 610, computer program 660 is arranged to render storefront files 630 to a file format that can be conveniently stored in mark database 680. (As examples of rendering, computer program 660 on web server 640 can convert storefront files 630 to PDF, MHT, HTML, JPG, TIF, GIF, or other file formats that enable the content relayed in the original storefront files 630 to be more conveniently notarized or stored.) The rendering is then stored in temporary storage 686 or in mark database 680 within documentation process 600, and computer program 660 then initiates notarization via web server 640.

Notarization process 300 is the same as that described above in reference to FIGS. 1 and 2.

After notarization, a notary file is returned to documentation process 600 via notary web server 310. The notary file is stored in mark database 680 along with the rendering of storefront files 630, creating a database record that can be used to document use of a mark.

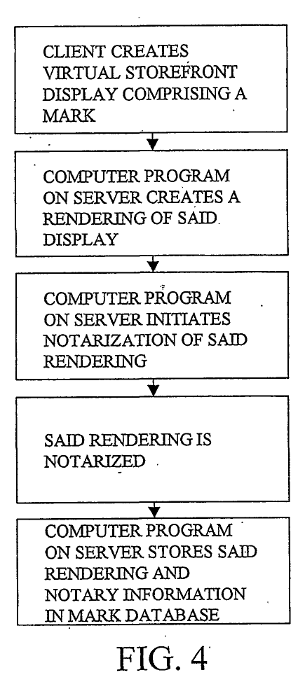

FIG. 4 illustrates the preferred embodiment of the method of the present invention. The client creates a virtual storefront display (one or more storefront files) comprising a mark. The computer program on a server then creates a rendering of the virtual storefront display and initiates notarization of the rendering. The rendering is then notarized, and notary information is stored, along with the rendering, in the mark database.

Printouts of the renderings stored in the mark database can be used as specimens in trademark and service mark registration applications.

In one embodiment of the invention, banner ads are used to advertise recently listed goods or services. Any such banner ad is hyperlinked so that when a user clicks on it the user is taken to a web page displaying contents of storefront files 110, 520, or 630, or will be taken to a page that has a listing or search function providing additional hyperlinks to various goods or services for sale. The banner ads are displayed by web server 210, 520, or 630. Alternatively they can be displayed by storefront web server 620 or on any other web server or web site.

In another embodiment, goods or services that are for sale will be listed in email and distributed via email mailing lists. For example, new customers or clients of the service provider who run documentation processes 200, 500, or 600 may become members of the mailing list, said mailing list members receiving periodic updates of new goods and services offers.

The invention will now be described by the following non-limiting examples.

### EXAMPLE 1

Company XYZ offers an Internet-based service (virtual storefront) whereby clients can list and display, in an Internet store, goods and services that are for sale. A client, ABC Company, wishing to list a new item, logs onto Company XYZ's web site (web server) to provide input to online forms and upload data, thereby creating virtual storefront files (storefront files) that web users will be able to access via a global information network In the present example, the client (Company ABC) wishes to use a new trademark (mark A) in conjunction with jars of jelly beans sold by Company ABC. Company ABC, after logging into Company XYZ's web site, enters into a form their address, telephone number, a description of the product (jars of jelly beans), and the price of a jar of jelly beans, all of which information will be displayed when viewers display the jelly bean virtual storefront web page in their browsers. In addition, the client uses the online forms on the web site to upload an image file of a jar of jelly beans to include as a storefront file for display in the virtual storefront web page. Company ABC's trademark (“mark A”) is clearly visible on the jar in the image file. Once Company ABC clicks on the upload button, thereby concluding their interactive session at the web site, the computer program on Company XYZ's web server takes the information from the online forms, along with the uploaded image file, and uses the information and image file to create an HTML file (storefront file), said HTML file comprising appropriate HTML tags to display the image of the jar of jelly beans from the image file (also a storefront file). The computer program then accesses the HTML and image files (storefront files) via a global information network, stores them in the mark database, and renders the HTML file, including the image, into a PDF file, which is also stored in the mark database. The computer program then initiates notarization of the PDF file, via a global information network. After notarization, a notary file is returned to the computer program, via a global information network, and is stored in the mark database. The computer program then sends an email message to Company ABC, indicating that the storefront files have been successfully created, and that a PDF rendering of the storefront files has been created and notarized.

### EXAMPLE 2

Company ZZZ has an Internet site (virtual storefront), at which it advertises its accounting services. Each web page at the site clearly displays company ZZZ's service mark. To display web pages at its web site, Company ZZZ's storefront web server accesses various storefront files, including HTML and image files. Company XXX offers a service whereby it provides electronic documentation to verify that a mark is being used at an Internet site. A representative from Company ZZZ, wishing to obtain such documentation for a page at Company ZZZ's web site, logs into Company X='s web site and submits a request to have the page documented by Company XXX's service. The computer program running on Company XXX's “documentation process” then accesses the indicated web page via a global information network at Company ZZZ's web site, renders it as a PDF file, and stores the PDF file in its mark database. The computer program then initiates notarization of the PDF file, via a global information network After notarization, a notary file is returned to the computer program, via a global information network, and is stored in the mark database. The computer program then sends an email message to Company ZZZ, indicating that a PDF rendering of the storefront files has been created and notarized.

In the claims that follow, it should be understood that the word “trademark” used in the claims is intended to include and mean “service mark”, “trade name”, “mark” or any other indicator of source or origin of goods and/or services. The phrase “global information network” is intended to include any and all computer networks. In a preferred embodiment, the global information network comprises the Internet. Also in a preferred embodiment, the global information network includes nodes (computers connected to the network) in at least two states of the United States, or at least in one state and a foreign country, or at least one Indian reservation and a state, or in at least two different jurisdictions that would qualify as “use in commerce” under the Lanham Act definition. It should be appreciated, however, that common law trademark rights arise from intrastate use of a mark, and that “use in commerce” under the Lanham Act is not necessary to establish common law rights in a trademark or service mark. Hence, the present invention as claimed is not intended to be limited in scope to documenting “use of a mark in commerce”. Although this is preferred, the invention as claimed is also useful in documenting use of a mark anywhere to establish common law rights.

Thus, it is seen that the objects of the invention are efficiently obtained, although changes and modifications to the invention will be readily apparent to those having ordinary skill in the art, and these changes and modifications are intended to be within the scope of the invention as claimed.

What is claimed is:

1. A method of documenting first use of a trademark comprising:
posting said trademark in a virtual storefront file accessible over a global information network;
retrieving said storefront file;
rendering said retrieved storefront file into a storable file format;
storing said rendered retrieved storefront file in a memory; and,
notarizing said rendered retrieved storefront file to document a date and time of first use of said trademark.

2. The method of documenting first use of a trademark recited in claim 1 wherein said memory is a temporary storage memory device.

3. The method of documenting first use of a trademark recited in claim 1 wherein said memory is a database.

4. The method of documenting first use of a trademark recited in claim 1 wherein first use is first use “in commerce” which the Congress of the United States of America can regulate under the United States Constitution.

5. The method of documenting first use of a trademark recited in claim 1 wherein said rendered retrieved storefront file is in a format selected from the group consisting of PDF, MHT, HTML, JPG, TIF and GIF.

6. The method of documenting first use of a trademark recited in claim 1 wherein said storefront file is located in a location remote from a location where said rendering step is performed.

7. The method of documenting first use of a trademark recited in claim 1 wherein said virtual storefront file is selected from the group consisting of web pages, emails and data files.

8. The method of documenting first use of a trademark recited in claim 1 wherein said virtual storefront file contains information pertaining to goods or services for sale.

9. The method of documenting first use of a trademark recited in claim 1 wherein said steps of retrieving said storefront file, rendering said retrieved storefront file into a storable file format, and storing said rendered retrieved storefront file in a memory are performed by a computer program operatively arranged to run on a web server.

10. The method of documenting first use of a trademark recited in claim 1 wherein said step of notarizing said rendered retrieved storefront file to document a date and time of first use of said trademark is performed at a location remote from all other steps in said method.

11. A method of documenting first use of a trademark recited in claim 1 wherein said storefront file is transmitted from a virtual storefront to a web server over said global information network.

12. A method of documenting first use of a trademark recited in claim 1 wherein said notarization step creates a notary file, and said notary file is transmitted to a web server via said global information network.

13. A method of documenting first use of a trademark recited in claim 1 wherein said steps of retrieving, rendering and storing are performed by a computer program running on said web server.

14. A method of documenting first use of a trademark, comprising:
posting said trademark in a virtual storefront file accessible over a global information network; and,
implementing an automatic computerized documentation process to document first use of said trademark.

15. A method of documenting first use of a trademark, comprising:
posting said trademark in a virtual storefront file accessible over a global information network;
retrieving said storefront file;
rendering said retrieved storefront file into a storable file format; and,
storing said rendered retrieved storefront file in a memory, wherein said stored storefront file includes information related to a date and time of first use of said trademark.

16. An apparatus for documenting first use of a trademark, comprising:
means for posting said trademark in a virtual storefront file accessible over a global information network;
means for retrieving said storefront file;
means for rendering said retrieved storefront file into a storable file format;
means for storing said rendered retrieved storefront file in a memory; and,
means for notarizing said rendered retrieved storefront file to document a date and time of first use of said trademark.

17. The apparatus for documenting first use of a trademark recited in claim 16 wherein said means for posting said trademark in a virtual storefront file accessible over a global information network comprises a general purpose computer specially programmed to post said trademark in said virtual storefront file.

18. The apparatus for documenting first use of a trademark recited in claim 16 wherein said means for retrieving said storefront file comprises a retrieval method that use file transfer protocol.

19. The apparatus for documenting first use of a trademark recited in claim 16 wherein said means for retrieving said storefront file comprises email.

20. The apparatus for documenting first use of a trademark recited in claim 16 wherein said means for rendering said retrieved storefront file into a storable file format comprises a general purpose computer specially programmed to perform said rendering.

21. The apparatus for documenting first use of a trademark recited in claim 16 wherein said means for storing said rendered retrieved storefront file in a memory comprises a general purpose computer specially programmed to perform said storing.

22. The apparatus for documenting first use of a trademark recited in claim 16 wherein said means for notarizing said rendered retrieved storefront file to document a date and time of first use of said trademark comprises a general purpose computer specially programmed to perform said notarization.
